(19) United States
(12) Patent Application Publication
(10) Pub. No.: US 2009/0183999 A1
(43) Pub. Date: Jul. 23, 2009

(54) GAS SENSOR ELEMENT AND METHOD

(76) Inventors: Alfredo Ibarra, Coahuila (MX); Marsha Nottingham, Howell, MI (US)

Correspondence Address: Paul L. Marshall;Delphi Technologies, Inc., Legal Staff-MC 480-410-202, P.O. Box 5052, Troy, MI, 48007, US

(21) Appl. No.: 12/016,384

(22) Filed: Jan. 18, 2008

(51) Int. Cl. G01N 27/26

(52) U.S. Cl. 205/775; 204/427

(57) ABSTRACT

Disclosed herein is a gas sensor cell comprising a solid electrolyte layer comprising a first solid electrolyte layer surface, a sensor electrode disposed on the first solid electrolyte layer surface, a reference electrode disposed on the first solid electrolyte layer surface, and an insulating layer comprising a first insulating layer surface and a second insulating layer surface opposite the first insulating layer surface, wherein the first insulating layer surface is disposed on the first solid electrolyte layer surface, and wherein the sensor electrode is in fluid communication with a gas. Also disclosed is a method of adjusting an impedance of the gas sensor cell, comprising adjusting a structural dimension of a sensing end of the gas sensor cell, wherein the sensing end comprises the sensor electrode and the reference electrode.

### BACKGROUND

Gas sensors are employed in a variety of applications requiring qualitative and quantitative analyses of gases, and frequently operate based on electrochemical reactions. A conventional gas sensor for use in conjunction with an internal combustion engine such as a conventional oxygen sensor, generally comprises an ionically conductive solid electrolyte material, a catalytic electrode having a protective overcoat on the sensor's exterior exposed to an exhaust resulting from the operation of the internal combustion engine, and an electrode on the sensor's interior exposed to a known gas concentration. The known gas concentration is generally ambient air or a pumped air reference.

Sensors that are generally employed in automotive oxygen sensing applications often use a zirconia-based electrochemical galvanic cell operating in potentiometric mode to detect the relative amounts of oxygen present. When opposite surfaces of this galvanic cell are exposed to different oxygen partial pressures, an electromotive force (emf) develops between the electrodes on the opposite surfaces of the zirconia electrolyte according to the Nernst equation:

$$E = ( \frac{R T}{4 F} ) ln ( \frac{{( P {O}_{2} )}_{ref}}{( P {O}_{2} )} )$$

wherein E=emf, R=the universal gas constant, F=Faraday's constant, T=an absolute temperature of the gas, (PO₂)_{ref}=oxygen partial pressure of the reference gas, and (PO₂)=oxygen partial pressure of the sensed gas.

Conventional automotive oxygen sensors, however, have several drawbacks, including high cost of manufacture and a lack of a general method of controlling the impedance of the sensor. For example, while the same electrode ink can be used for printing the sensor electrode and the reference electrode, separate and/or different manufacturing steps are required in order to print each electrode on opposing surfaces of the electrolyte.

Moreover, there is no general method of controlling the impedance of the sensor using an electrolyte having a constant thickness when the sensor and reference electrodes are disposed on opposing sides of the electrolyte.

Consequently, there exists a need for a gas sensor cell that is capable of sensing gases without the need for complex manufacturing steps.

In addition, there exists a need for a gas sensor cell wherein the impedance can be easily adjusted.

### SUMMARY

Surprisingly, the present inventors have discovered that a gas sensor cell comprising a solid electrolyte layer comprising a first solid electrolyte layer surface, a sensor electrode disposed on the first solid electrolyte layer surface, a reference electrode disposed on the first solid electrolyte layer surface, and an insulating layer comprising a first insulating layer surface and a second insulating layer surface opposite the first insulating layer surface, wherein the first insulating layer surface is disposed on the first solid electrolyte layer surface, and wherein the sensor electrode is in fluid communication with a gas, such as oxygen in an automotive exhaust stream, is advantageous for sensing the gas, while reducing the manufacturing cost, and allowing for ease of impedance control.

In one embodiment, a gas sensor cell comprises a solid electrolyte layer comprising a first solid electrolyte layer surface, a sensor electrode disposed on the first solid electrolyte layer surface, a reference electrode disposed on the first solid electrolyte layer surface, and an insulating layer comprising a first insulating layer surface, a second insulating layer surface opposite the first insulating layer surface, and an opening, wherein the first insulating layer surface is disposed on the first solid electrolyte layer surface, the sensor electrode, and the reference electrode, wherein the opening extends from the second insulating layer surface to the sensor electrode, and wherein a gas is in fluid communication with the sensor electrode through the opening.

In one embodiment, a method of adjusting an impedance of a gas sensor cell comprises adjusting a structural dimension of a sensing end of the gas sensor cell, wherein the gas sensor cell comprises a solid electrolyte layer comprising a first solid electrolyte layer surface, a sensor electrode disposed on the first solid electrolyte layer surface, a reference electrode disposed on the first solid electrolyte layer surface, and an insulating layer comprising a first insulating layer surface and a second insulating layer surface opposite the first insulating layer surface, wherein the first insulating layer surface is disposed on the first solid electrolyte layer surface, wherein the sensor electrode is in fluid communication with a gas, and wherein the sensing end comprises the sensor electrode and the reference electrode.

### BRIEF DESCRIPTION OF THE DRAWINGS

Referring now to the drawings wherein like elements are numbered alike in several FIGURES:

FIG. 1 is a cross section of an oxygen sensor cell for determining a concentration of oxygen in an exhaust gas in accordance with a non-limiting exemplary embodiment;

FIG. 2A-B are cross sections of an oxygen sensor cell for determining a concentration of oxygen in an exhaust gas in accordance with another non-limiting exemplary embodiment;

FIG. 3A-C are top views of the first solid electrolyte layer surface of an oxygen sensor cell, through a second and a first insulating layer surfaces, in accordance with another non-limiting exemplary embodiment; and

FIG. 4A-C are respectively top, cross-sectional, and bottom views of a non-limiting advantageous embodiment of an oxygen sensor cell.

### DETAILED DESCRIPTION

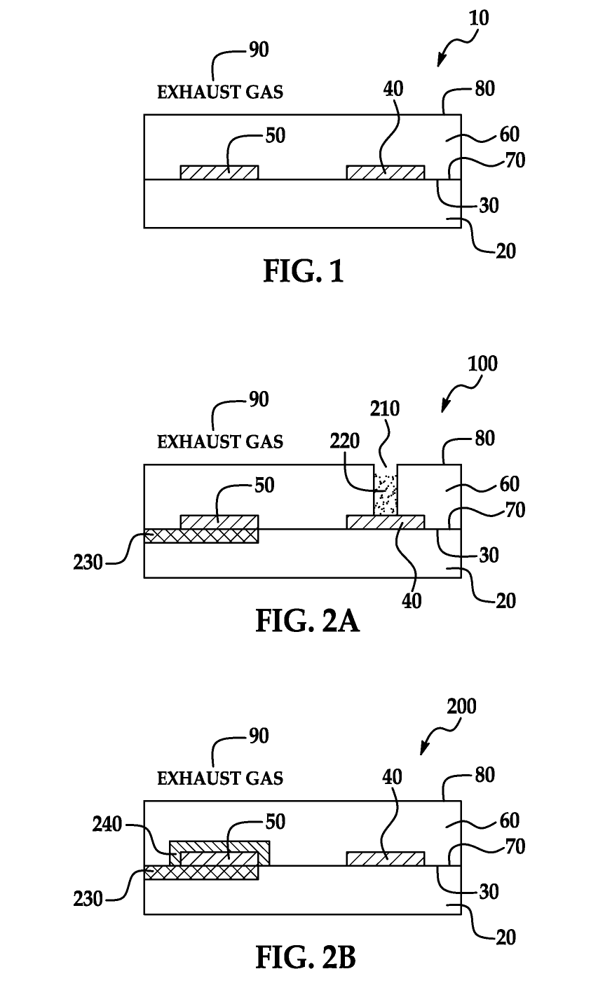

Referring to FIG. 1, a cross section of an oxygen sensor cell 10 for determining a concentration of oxygen in an exhaust gas in accordance with a non-limiting exemplary embodiment is illustrated. Although described in connection with an oxygen sensor, it is to be understood that the sensor, which can comprise any geometry (e.g., conical, flat plate, planar, and the like) could be a nitrogen oxide sensor, hydrogen sensor, hydrocarbon sensor, or the like. Furthermore, while oxygen is the reference gas used in the description disclosed herein, it should be understood that other gases could be employed as a reference gas, such as ammonia, hydrogen, or the like.

The oxygen sensor cell 10 comprises a solid electrolyte layer 20 comprising a first solid electrolyte layer surface 30, a sensor electrode 40 disposed on the first solid electrolyte layer surface 30, and a reference electrode 50 disposed on the first solid electrolyte layer surface 30, creating an electrochemical cell. That is, the sensor electrode 40 and the reference electrode 50 are disposed on the same solid electrolyte layer surface 30. Oxygen sensor cell 10 further comprises an insulating layer 60 comprising a first insulating layer surface 70 and a second insulating layer surface 80 opposite the first insulating layer surface 70, wherein the first insulating layer surface 70 is disposed on the first solid electrolyte layer surface 30. In this embodiment, the first insulating layer surface 70 is thus in intimate contact with sensor electrode 40 and reference electrode 50. The sensor electrode 40 is in fluid communication with a gas to be sensed. In this embodiment, a non-limiting example of the gas to be sensed is oxygen, such as oxygen present in a stream of an exhaust gas 90 produced during the operation of an internal combustion engine (not shown).

The solid electrolyte layer 20 generally comprises any electrolyte material that permits the transfer of oxygen ions while inhibiting (i.e., limiting or advantageously stopping) the physical passage of gases. The solid electrolyte layer 20 is not limited by size, and can be any size capable of providing sufficient ionic communication for the oxygen sensor cell, for a plurality of cells (not shown), and/or for other cells and/or components (not shown).

Non-limiting examples of electrolyte materials include zirconia, ceria, calcia, yttria, lanthanum oxide, magnesia, indium oxide, and the like, as well as combinations comprising at least one of the foregoing electrolyte materials. In one advantageous embodiment, the electrolyte material is zirconia. In another advantageous embodiment, the solid electrolyte layer 20 comprises zirconia which is stabilized with calcium, barium, yttrium, magnesium, aluminum, lanthanum, cesium, gadolinium, ytterbium, scandium, and the like, and oxides thereof, as well as combinations comprising at least one of the foregoing electrolyte materials.

In one exemplary embodiment, the electrolyte material is yttria stabilized zirconia. The yttria stabilized zirconia can comprise up to about 16 weight percent (wt %) yttria, based on the total weight of the electrolyte material. Specifically, The yttria stabilized zirconia can comprise about 2 to about 14 wt % yttria, based on the total weight of the electrolyte material. In one advantageous embodiment, the yttria stabilized zirconia can comprise 3 to about 12 wt % yttria, based on the total weight of the electrolyte material.

The sensor electrode 40 is in intimate contact and ionic communication with the solid electrolyte layer 20. The sensor electrode 40 has electrical conducting capability and can advantageously also have gas diffusion capability (providing sufficient open porosity so that gas can diffuse throughout the electrode and to the interface region of the sensor electrode 40 and solid electrolyte layer 20). The sensor electrode 40 can comprise any catalyst capable of ionizing oxygen, including but not limited to, metals such as platinum, palladium, gold, osmium, rhodium, iridium, ruthenium, zirconium, yttrium, cerium, calcium, aluminum, and the like, as well as alloys of, oxides of, and combination comprising at least one of the foregoing catalysts. The sensor electrode 40 can include metal oxides such as zirconia and alumina that can increase the electrode porosity and increase the contact area between the electrode and the solid electrolyte layer 20.

Sensor electrode 40 can be applied to the solid electrolyte layer 20 using any method available to one with ordinary skill in the art, such as thin or thick film deposition techniques. Non-limiting examples of deposition techniques include spraying, spinning, dip-coating, and screen-printing, with screen-printing being advantageous due to simplicity, economy, and compatibility with, for example, co-fired processes such as co-firing with an unfired solid electrolyte layer.

In one embodiment, the sensor electrode 40 is applied using screen-printing in the form of a metal ink, which can be a slurry, a paste, or the like. The metal ink comprises metals, e.g., noble metals such as platinum, rhodium, palladium, and alloys thereof. In one advantageous embodiment, the metal ink comprises platinum. The metal ink can further comprise fugitive materials, metal oxides, binders, and the like. Metal oxides and fugitive materials can increase the electrode porosity and increase the contact area between the electrode and the solid electrolyte layer 20. Non-limiting examples of metal oxides include zirconia, alumina, and a combination thereof, among others. Non-limiting examples of fugitive materials include graphite, carbon black, starch, nylon, polystyrene, latex, other soluble organics (e.g., sugars and the like), and the like, as well as combinations comprising at least one of the foregoing fugitive materials. Non-limiting examples of binders include cellulose, ethylcellulose, and the like. The foregoing can be combined with enough solvent to form an ink having a suitable viscosity for the application method, such as screen-printing. Non-limiting examples of solvents include terpineol, ethanol, xylenes, toluene, methyl ethyl ketone, 2-(2-butoxyethoxy)ethanol, and the like, as well as combinations thereof.

Thus, in one non-limiting illustrative embodiment, a metal ink composition comprises about 75 to about 80 wt % platinum, about 6.5 to about 8 wt % zirconia, about 0.1 to about 0.5 wt % yttria, about 1.5 to about 2.1 wt % alumina, and about 11 to about 13.5 wt % fugitive material, based on the total solids content of the ink. The ink comprising the foregoing composition is formed using 2-(2-butoxyethoxy)ethanol as a solvent. The ink is screen printed onto a solid electrolyte layer, dried, and annealed, to form the sensor electrode 40. The sensor electrode 40 has a sufficient thickness to form the desired sensor cell, for example, a thickness of about 5 to about 50 micrometers (μm). The durability of sensor electrode 40 increases with increasing thickness, however, increasing thickness can adversely affect the sensitivity of the sensor electrode 40. Thus, a balance between durability and sensitivity exists, and as such, the desired balance can be achieved by controlling the thickness of the metal ink during screen-printing.

In one embodiment, the thickness of the sensor electrode 40 is about 0.1 to about 10 μm, and specifically about 1 to about 7 μm. In one advantageous embodiment, the thickness of the electrode is about 1 to about 5 μm.

Similar to the sensor electrode 40, the reference electrode 50 is also in intimate contact and ionic communication with the solid electrolyte layer 20. Reference electrode 50 has electrical conducting capability and can advantageously also have gas diffusion capability (providing sufficient open porosity so that gas can diffuse throughout the electrode and to the interface region of the reference electrode 50 and solid electrolyte layer 20). The reference electrode 50 can comprise any catalyst capable of ionizing oxygen, including but not limited to, metals such as platinum, palladium, gold, osmium, rhodium, iridium, ruthenium, zirconium, yttrium, cerium, calcium, aluminum, and the like, as well as alloys of, oxides of, and combinations comprising at least one of the foregoing catalysts. The reference electrode 50 can include metal oxides such as zirconia and alumina that can increase the electrode porosity and increase the contact area between the electrode and the solid electrolyte layer 20.

Reference electrode 50 can be applied to the solid electrolyte layer 20 using any of the methods disclosed above in reference to sensor electrode 40. The reference electrode 50 has a sufficient thickness to form the desired sensor cell, for example, a thickness of about 5 to about 50 micrometers (μm). The durability of reference electrode 50 increases with increasing thickness, however, increasing thickness can adversely affect the sensitivity of the reference electrode 50. Thus, a balance between durability and sensitivity exists, and as such, the desired balance can be achieved by controlling the thickness of the metal ink during screen-printing.

In one embodiment, the thickness of the reference electrode 50 is about 0.1 to about 10 μm, and specifically about 1 to about 7 μm. In one advantageous embodiment, the thickness of the electrode is about 1 to about 5 μm.

The manufacture of the oxygen sensor cell 10 provides for manufacturing sensor electrode 40 and reference electrode 50 on the same surface of the solid electrolyte layer 20, thus eliminating the difficulty and cost involved in manufacturing the electrodes on opposing surfaces of the solid electrolyte layer as is done in conventional gas sensors. In one advantageous embodiment, the ink used to screen-print the sensor electrode 40 and the reference electrode 50 is the same, thus printing both electrodes is effected in one manufacturing step.

The insulating layer 60 comprises a dielectric material such as a spinel (e.g., magnesium aluminate), alumina, zirconia, and the like, as well as combinations comprising at least one of the foregoing materials. In one advantageous embodiment, the insulating layer 60 comprises alumina.

Insulating layer 60 provides for fluid communication between the sensor electrode 40 and the exhaust gas 90, and it can be porous or, alternatively, free of pores with the proviso that sensor electrode 40 remains in fluid communication with the exhaust gas 90. This fluid communication can be maintained using any method available to one with ordinary skill in the art. In one embodiment, the insulating layer 60 is porous, and fluid communication between the sensor electrode 40 and the exhaust gas 90 is provided at least by diffusion of the exhaust gas through the porous insulating layer 60. If needed, other methods can be used in conjunction with the porosity of insulating layer 60 to facilitate this fluid communication. In another embodiment, the insulating layer 60 is non-porous and is an effective barrier for the diffusion of exhaust gas 90. In this embodiment, fluid communication is maintained by the formation of openings through the insulating layer that can provide fluid communication between the sensor electrode 40 and the exhaust gas 90. However, any other suitable method can be used in lieu of, or in conjunction with the foregoing openings.

Insulating layer 60 can be disposed using thin or thick film deposition techniques including sputtering, electron beam evaporation, chemical vapor deposition, screen printing, pad printing, ink jet printing, spinning, spraying, including flame spraying and plasma spraying, dip-coating and the like, of which screen-printing and/or dip-coating is advantageous. The insulating layer 60 can have a thickness of up to about 500 μm, with less than or equal to about 400 μm being advantageous.

Pores can be introduced into the insulating layer 60 using any method available to one with ordinary skill in the art. Non-limiting examples of such methods include the introduction of fugitive materials and the like into the insulating layer 60 prior to sintering, firing, and/or calcining. Thus, in one embodiment, a fugitive material such as graphite, carbon black, starch, nylon, polystyrene, latex, or the like, as well as combinations thereof, is combined with the dielectric material. A layer is then disposed on the solid electrolyte layer 20 (as well as sensor electrode 40 and reference electrode 50). Upon firing, sinter, annealing, calcining, and/or the like, a porous insulating layer 60 is produced, which provides for diffusion of the gas to be sensed, such as exhaust gas 90.

After deposition of the insulating layer 60, the oxygen sensor cell 10 can be sintered. Sintering occurs at temperatures up to about 1,550° C., more specifically about 1,000 to about 1,550° C., more specifically about 1200 to about 1550° C., more specifically about 1400 to about 1550° C., and even more specifically about 1,485 to about 1,520° C. In one advantageous embodiment, the oxygen sensor cell 10 can be sintered at a temperature of about 1,425 to about 1,510° C. Sintering is conducted for a duration of up to about 180 minutes, more specifically about 10 to about 180 minutes, and even more specifically about 50 to about 160 minutes. In one advantageous embodiment, sintering is conducted for a duration of about 100 to about 140 minutes. In one exemplary embodiment, sintering is conducted for a duration of about 100 to about 140 minutes at a temperature of about 1425 to about 1510° C.

Referring now to FIG. 2A, a cross section of an oxygen sensor cell 200 for determining a concentration of oxygen in an exhaust gas in accordance with another non-limiting exemplary embodiment is illustrated. In this embodiment, the oxygen sensor cell 100 comprises an insulating layer 60 that is free of pores. The insulating layer 60 free of pores can comprise any of the above described insulating layer materials, with the proviso that after firing and/or sintering, and/or during normal operation of the oxygen sensor cell, the insulating layer 60 acts as a barrier to the diffusion of the exhaust gas 90 and does not otherwise allow the diffusion of the exhaust gas 90. The insulating layer 60 thus further comprises an opening 210 extending from the second insulating layer surface 80 to the sensor electrode 40. During the operation of the internal combustion engine (not shown), the exhaust gas 90 is in fluid communication with the sensor electrode 40 through the opening 210.

The opening 210 comprises a cross-sectional geometry of any shape, such as circular, square, triangular, and the like. The number of openings 210 which provide fluid communication between the exhaust gas 90 and the sensor electrode 40 and the dimension of their cross section can be adjusted according to required specifications, such as the dimension of the sensor electrode 40, the required rate of diffusion of the exhaust gas 90, and the like. Generally, the cross-sectional dimension of the opening 210 is about the same as the width of the sensor electrode 40, however, it can also be greater than or less than such width. In one embodiment, the cross-sectional geometry is circular. In one advantageous embodiment, the cross-sectional geometry is circular, having a diameter equal to the width of sensor electrode 40, plus or minus about 10 percent of the width of the sensor electrode 40.

The opening 210 can be formed using any suitable method available to one with skill in the art. One such method is to use a hole punch to create the opening 210. Thus, in one exemplary embodiment, a hole punch (not shown) is used, which has a cross-sectional geometry that matches the desired shape of the opening 210 and is connected to a device (not shown) for applying a downward force, such as a hydraulic, pneumatic, or hand-operated press. The hole punch can be moved vertically along its long axis.

The opening 210 can be free of filler. However, this can cause the sensor electrode 40 to be exposed to contaminants such as lead and/or sulfur that can be present in exhaust gas 90. Thus, it can be advantageous for the opening 210 to comprise a porous filler material 220 effective at reducing the exposure of sensor electrode 40 to contaminants. One advantageous porous filler material for use herein is porous alumina, which can be applied using any of the above described methods. However, any suitable material can be used as long as it does not adversely affect the sensor element 100.

The oxygen sensor cell 100 comprises a channel 230, such as a slit, hole, aperture, or the like. The channel 230 provides for fluid communication between the reference electrode 50 and a reference gas (not shown). In one advantageous embodiment, the reference gas is atmospheric air, but it can be any reference gas such as hydrogen, oxygen, ammonia, and the like.

Referring now to FIG. 2B, a cross section of an oxygen sensor cell 200 for determining a concentration of oxygen in an exhaust gas in accordance with another non-limiting exemplary embodiment is illustrated. In this embodiment, the oxygen sensor cell 200 comprises an insulating layer 60, which is porous, that is, comprises pores effective at providing fluid communication between the exhaust gas 90 and the electrodes during the operation of the internal combustion engine (not shown). The insulating layer 60 can comprise any of the above described insulating layer materials, with the proviso that after firing and/or sintering, and/or during normal operation of the oxygen sensor cell, the insulating layer 60 provides for the diffusion of the exhaust gas 90 and for fluid communication between the sensor electrode 40 and the exhaust gas 90.

In this embodiment, a diffusion barrier 240 is disposed on the reference electrode 50. The diffusion barrier 240 is effective at preventing fluid communication between the exhaust gas 90 and the reference electrode 50, which can adversely affect the oxygen sensor cell 200. The diffusion barrier 240 comprises any of the above described material effective at preventing the diffusion of the exhaust gas 90, such as alumina. The diffusion barrier 240 can be disposed on the reference electrode 50 using any of the above described methods. It can be of any thickness effective at preventing the diffusion of the exhaust gas 90. The diffusion barrier 240 can have a thickness of up to about 50 μm, specifically about 1 nanometer (nm) to about 50 μm, more specifically about 100 nm to about 40 μm, and more specifically about 1 to about 30 μm. In one advantageous embodiment, the diffusion barrier 240 has a thickness of about 1 to about 10 μm.

The oxygen sensor cell 200 can advantageously comprise a channel 230, such as a slit, hole, aperture, or the like. The channel 230 provides for fluid communication between the reference electrode 50 and a reference gas (not shown). In one advantageous embodiment, the reference gas is atmospheric air. In one embodiment (not shown), the diffusion barrier 240 can further be disposed between the channel 230 and the insulating layer 60 if its absence permits the adverse diffusion of the reference gas from channel 230 into the insulating layer 60.

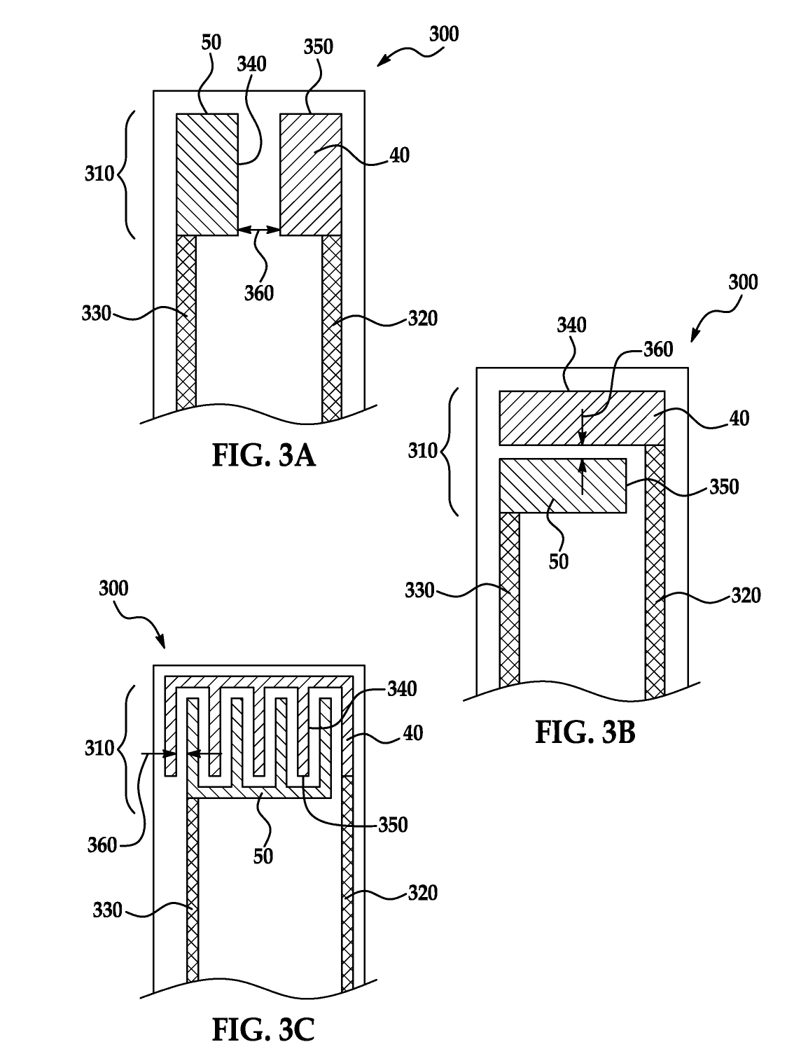

Referring now to FIG. 3A-C, illustrated is a top view of the first solid electrolyte layer surface of oxygen sensor cell 300, through the second and first insulating layer surfaces (not shown), in accordance with another non-limiting exemplary embodiment.

The oxygen sensor cell 300 comprises electrical leads 320 and 330. At the sensing end 310 of the oxygen sensor cell 300, the electrical leads 320 and 330 are disposed in physical contact and in electrical communication with sensor electrode 40 and reference electrode 50 respectively. Further, electrical leads 320 and 330 can be disposed in electrical communication with other components generally present in a gas sensor, such as an electromagnetic shield (not shown), an external power source (not shown), a processor (not shown), or the like, as well as combinations thereof, directly or through contact with contact pads (not shown).

Sensor electrode 40 and reference electrode 50 are of a rectangular shape (FIG. 3A-B) or an interfitting comb-shaped plurality of rectangular shapes (FIG. 3C). However, any shape can be used herein, such as circular, spiral, square, or the like. In the exemplary embodiment illustrated in FIG. 3A-C, sensor electrode 40 and reference electrode 50 can have a length 340, and a width 350. While the length 340 and the width 350 are shown to be the same for each electrode, in some embodiments, the length 340 and/or the width 350 of sensor electrode 40 can be different from the length 340 and/or the width 350 of reference electrode 50. Sensor electrode 40 and reference electrode 50 are separated by a separation distance 360.

The length 340, width 350, and separation distance 360 can be of any suitable size, which can depend on several factors such as, but not limited to, the size of the oxygen sensor cell, the amount of rectangular shapes or “fingers” (i.e., when an interfitting comb-shaped plurality of fingers is used), and the like. For example, in one embodiment, the oxygen sensor cell 300 of FIG. 3A-B can have a length 340 of about 0.1 to about 5 millimeters (mm), a width 350 of about 0.05 to about 2 mm, and a separation distance of about 0.05 to about 3 mm. The oxygen sensor cell 300 of FIG. 3C can have a length 340 of about 0.1 to about 5 millimeters (mm), a width 350 of about 0.05 to about 0.5 mm, and a separation distance of about 0.05 to about 0.5 mm.

Several factors contribute to the impedance of a gas sensor cell, including, but not limited to, the size and/or dimensions of the sensor and reference electrodes, and the separation distance between them. The size and/or dimensions of the sensor and reference electrodes, and the separation distance between them are generally constant in a conventional sensor, where the sensor and reference electrodes are disposed on opposing sides of an electrolyte layer. In addition, the separation distance is determined by the thickness of the electrolyte layer.

However, the gas sensor cell disclosed herein comprises the sensor and reference electrodes disposed on the same surface of the solid electrolyte layer, and as such the separation distance is independent of the thickness of the solid electrolyte layer. As such, the impedance of the gas sensor cell can be adjusted by adjusting any of the dimensions of the electrodes such as the length of the sensor electrode, the width of the sensor electrode, the length of the reference electrode, the width of the reference electrode, the separation distance between the sensor and reference electrodes, or a combination of two or more of the foregoing dimensions. The foregoing dimensions are collectively referred to as dimensions of the sensing end of the gas sensor cell.

Thus, one embodiment is a method of adjusting the impedance of a gas sensor cell, comprising adjusting at least one structural dimension of the sensing end of the gas sensor cell. Adjusting can be effected by, for example, increasing, i.e., increasing the length and/or width of the electrodes, and/or the separation distance between the electrodes; decreasing, i.e., decreasing the length and/or width of the electrodes, and/or the separation distance between the electrodes; and the like.

In one exemplary embodiment, the impedance of oxygen sensor cell 300 can be adjusted by changing the length 340 of the electrodes, the width 350, and/or the separation distance 360. In another exemplary embodiment, it can be advantageous for ease of impedance control to keep the length 340 and the width 350 constant and change the separation distance 360 until an optimal impedance value is achieved, which can be determined by someone with ordinary skill in the art. In another exemplary embodiment, it can be advantageous for ease of impedance control to keep the separation distance 360 constant while changing the length 340 and/or the width 350 until an optimal impedance value is achieved. However, in any embodiment, impedance control can be effected by changing the length 340, the width 350, the separation distance 360, or by changing a combination of two or more of the foregoing. In addition, it is to be understood that the foregoing methods are non-limiting, and a suitable method for adjusting the impedance can be determined by one with ordinary skill in the art. For example, in one embodiment (not shown), the sensor and reference electrodes are of a concentric circular or spiral shape. Impedance can thus be adjusted by adjusting one or more of the spiral or circular shape's structural dimensions such as the separation distance (measured as radial distance between two consecutive arcs), radius, perimeter (circle), length (spiral), and the like.

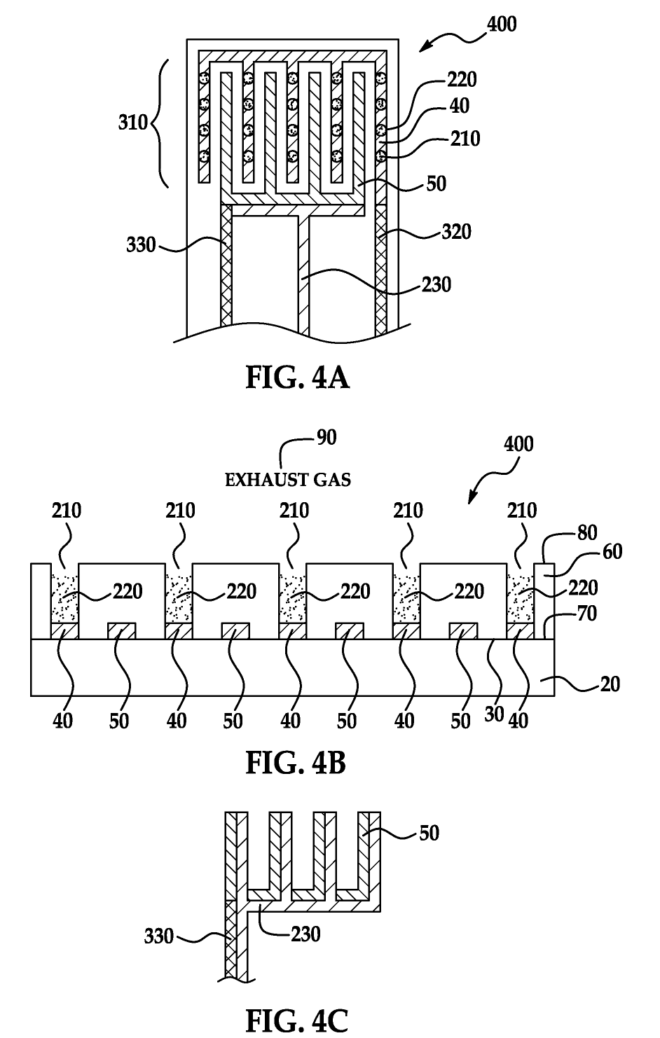

Referring now to FIG. 4A-B, in accordance with another non-limiting advantageous embodiment, a top view (FIG. 4A) and a cross-sectional view (FIG. 4B) of oxygen sensor cell 400 is illustrated. The oxygen sensor cell 400 comprises electrical leads 320 and 330, in physical contact and electrical communication with sensor electrode 40 and reference electrode 50. Sensor and reference electrodes 40 and 50 are of an interfitting comb-shaped plurality of fingers. These fingers are of a length 340, width 350, and are separated by a distance 360. An insulating layer 60 comprising a first insulating layer surface 70 and a second insulating layer surface 80 opposite the first insulating layer surface 70 is disposed on the solid electrolyte layer 20 and is in intimate contact with the sensor electrode 40 and the reference electrode 50. The insulating layer 60 is effective as a barrier to the diffusion of the exhaust gas 90 and does not otherwise allow the diffusion of the exhaust gas 90 during the operation of the internal combustion engine (not shown). The insulating layer 60 comprises several cylindrical openings 210 extending through the insulating layer 60 (from the insulating layer surface 80 to the insulating layer surface 70) and is effective at providing fluid communication between the exhaust gas 90 and the sensor electrode 40. The openings 210 do not provide for fluid communication between the exhaust gas 90 and the reference electrode 50. The diameter of the opening is about the width 350 of the sensor electrode 40. The openings 210 comprise a porous filler material 220 comprising a porous alumina, disposed therein in the form of alumina slurry and/or ink. However, any suitable material can be used as long as it does not adversely affect the sensor cell 400. Oxygen sensor cell 400 further comprises a channel 230, such as a slit, hole, aperture, or the like (illustrated herein is a T-shaped channel). The channel 230 provides for fluid communication between the reference electrode 50 and a reference gas (not shown). The channel 230 does not provide for fluid communication between the sensor electrode 40 and the reference gas.

Referring to FIG. 4C, in another exemplary embodiment, a channel 230, which is a reference air channel, is disposed on a first side of reference electrode 50, opposite a second side of reference electrode 50, wherein the second side of reference electrode 50 is opposite the first solid electrolyte layer surface. As in FIG. 4B, the channel 230 provides for fluid communication between the reference electrode 50 and the reference gas (not shown), but does not provide for fluid communication between the sensor electrode 40 and the reference gas. In one embodiment, the channel 230 is formed within the solid electrolyte layer, and is in intimate contact with the reference electrode 50. The channel 230 in FIG. 4C can be used in conjunction with or in lieu of the reference channel 230 in FIG. 4B. However, as previously disclosed, there is no limitation as to the shape of the channel 230, and its shape can be determined by anyone with ordinary skill in the art.

The gas sensor cells disclosed herein can be used alone or in combination with other gas sensor cells, and can comprise additional layers and/or components with the proviso that they do not adversely affect the operation of the gas sensor cells. They can be used to form gas sensor elements and/or gas sensors, such as but not limited to oxygen, NOx, hydrogen, and/or ammonia sensor elements and/or sensors.

This written description uses figures in reference to exemplary embodiments to disclose the invention, including the best mode, and also to enable any person skilled in the art to make and use the invention. The patentable scope of the invention is defined by the claims, and may include other embodiments that occur to those skilled in the art. Such other embodiments are intended to be within the scope of the claims if they have structural elements that do not differ from the literal language of the claims, or if they include equivalent structural elements with insubstantial differences from the literal language of the claims.

All ranges disclosed herein are inclusive of the endpoints, and the endpoints are independently combinable with each other. Further, it is understood that disclosing a range is specifically disclosing all ranges formed from any pair of any upper range limit and any lower range limit within this range, regardless of whether ranges are separately disclosed. It is not intended that the scope of the invention be limited to the specific values recited when defining a range.

The use of the terms “a”, “an”, “the”, and similar referents in the context of describing the invention (especially in the context of the following claims) are to be construed to cover both the singular and the plural, unless otherwise indicated herein or clearly contradicted by context. Further, it should be noted that the terms “first”, “second”, and the like herein do not denote any order, quantity, or importance, but rather are used to distinguish one element from another.

The modifier “about” used in connection with a quantity is inclusive of the stated value and has the meaning dictated by the context (e.g., it includes the degree of error associated with measurement of the particular quantity).

The term “in fluid communication” as used herein refers to a structural relationship between elements which permits conveyance of fluid therebetween and does not necessarily imply the presence of a fluid. The term “fluid” as used herein refers to a liquid or, advantageously, gaseous material or a material which includes components which are liquid or, advantageously, gaseous, or both.

As used herein, “disposed on” refers to in intimate contact with.

“Adjusting”, as used herein, refers to changing and/or controlling the value of, value being a measurable quantity such as impedance, structural dimension, and the like.

What is claimed is:

1. A gas sensor cell, comprising:
a solid electrolyte layer comprising a first solid electrolyte layer surface;
a sensor electrode disposed on the first solid electrolyte layer surface;
a reference electrode disposed on the first solid electrolyte layer surface; and
an insulating layer comprising a first insulating layer surface and a second insulating layer surface opposite the first insulating layer surface;
wherein the first insulating layer surface is disposed on the first solid electrolyte layer surface; and
wherein the sensor electrode is in fluid communication with a gas.

2. The gas sensor cell of claim 1, wherein the reference electrode is not in fluid communication with the gas.

3. The gas sensor cell of claim 1, wherein the insulating layer comprises alumina.

4. The gas sensor cell of claim 1, wherein the solid electrolyte layer comprises zirconia.

5. The gas sensor cell of claim 1, wherein the insulating layer is effective at blocking the diffusion of the gas, and comprises an opening extending from the second insulating layer surface to the sensor electrode, which provides for fluid communication between the sensor electrode and the gas.

6. The gas sensor cell of claim 5, wherein the opening comprises a porous material.

7. The gas sensor cell of claim 6, wherein the porous material comprises porous alumina.

8. The gas sensor cell of claim 1, wherein the reference electrode is in fluid communication with a gas reference channel.

9. The gas sensor cell of claim 8, wherein the gas reference channel provides for fluid communication between a reference gas and the reference electrode.

10. The gas sensor cell of claim 9 wherein the gas reference channel does not provide for fluid communication between the reference gas and the sensor electrode.

11. The gas sensor cell of claim 1, wherein the insulating layer is effective at providing fluid communication between the gas and the sensor electrode, and further wherein a diffusion barrier layer is disposed on the reference electrode.

12. The gas sensor cell of claim 11, wherein the diffusion barrier layer is effective at blocking fluid communication between the reference electrode and the gas.

13. A gas sensor cell, comprising:
a solid electrolyte layer comprising a first solid electrolyte layer surface;
a sensor electrode disposed on the first solid electrolyte layer surface;
a reference electrode disposed on the first solid electrolyte layer surface; and
an insulating layer comprising a first insulating layer surface, a second insulating layer surface opposite the first insulating layer surface, and an opening;
wherein the first insulating layer surface is disposed on the first solid electrolyte layer surface, the sensor electrode, and the reference electrode;
wherein the opening extends from the second insulating layer surface to the sensor electrode; and
wherein a gas is in fluid communication with the sensor electrode through the opening.

14. The gas sensor cell of claim 13, wherein the sensor electrode and the reference electrode comprise an interfitting comb-shaped plurality of rectangular fingers.

15. A method of adjusting an impedance of a gas sensor cell, comprising:
adjusting a structural dimension of a sensing end of the gas sensor cell, wherein the gas sensor cell comprises:
a solid electrolyte layer comprising a first solid electrolyte layer surface;
a sensor electrode disposed on the first solid electrolyte layer surface;
a reference electrode disposed on the first solid electrolyte layer surface; and
an insulating layer comprising a first insulating layer surface and a second insulating layer surface opposite the first insulating layer surface;
wherein the first insulating layer surface is disposed on the first solid electrolyte layer surface;
wherein the sensor electrode is in fluid communication with a gas; and
wherein the sensing end comprises the sensor electrode and the reference electrode.

16. The method of claim 15, wherein the sensor electrode and the reference electrode are rectangular in shape and comprise a separation distance, wherein the sensor electrode comprises a sensor electrode length and a sensor electrode width, wherein the reference electrode comprises a reference electrode length and a reference electrode width, and further wherein adjusting the structural dimension of the sensing end of the gas sensor cell comprises adjusting the separation distance, the sensor electrode length, the sensor electrode width, the reference electrode length, the reference electrode width, or a combination comprising two or more of the foregoing structural dimensions of the sensing end.
